(19) United States
(12) Patent Application Publication
(10) Pub. No.: US 2005/0254537 A1
(43) Pub. Date: Nov. 17, 2005

(54) High power semiconductor laser lighting device

(75) Inventors: Sheng-Pin Su, Chung Li City (TW); Chun-Kun Yu, Tao Yuan City (TW); Daniel Jih Huah Wu, Chung Li City (TW)

Correspondence Address: TROXELL LAW OFFICE PLLC, Suite 1404, 5205 Leesburg Pike, Falls Church, VA, 22041, US

(73) Assignee: EINS OE-TECH CO., LTD.

(21) Appl. No.: 10/846,525

(22) Filed: May 17, 2004

(51) Int. Cl. H01S 3/04

(52) U.S. Cl. 372/43.01; 372/34; 372/36

(57) ABSTRACT

A high power semiconductor laser lighting device has a housing, a fan module arranged in an exhaust hole in the housing, a base connected to the bottom wall of the housing and disposed on a side of the fan module, and a semiconductor laser constant-temperature module. The base has a driving unit with at least one high power electronic component connected to fins of the fan module. The semiconductor laser constant-temperature module has a metallic partition to enclose a vacuum formed in a front portion of the housing, and a heat insulation layer arranged in the vacuum. The metallic partition has a side connecting the heat dissipation plate and an opposite side connecting a heating portion of a thermoelectric cooling chip, which includes a cooling portion connecting to a semiconductor laser lighting module. The high power semiconductor laser lighting device to keep an output power thereof constant within various environments.

### BACKGROUND OF THE INVENTION

1. Field of the Invention

The present invention relates to a high power semiconductor laser lighting device, and particularly relates to a high power semiconductor laser lighting device with a housing including a semiconductor laser module, a fan module, a driving unit, and the high power semiconductor laser lighting device keep an output power thereof constant within various environments.

2. Background of the Invention

Referring to FIG. 1, a first conventional high power semiconductor laser lighting device adopted for industrial instruments includes a housing 60, a resilient mount 65, a high power laser module 70, a controlling mask 75, at least one fan 80 and a voltage regulator circuit unit 85. The resilient mount 65 is disposed in a bottom of the housing 60, and has an insulating post 66 arranged in a front portion thereof and an insulating spring 67 arranged in a rear portion thereof. The high power laser module 70 includes a heat dissipation ring 71 disposed on a top of the resilient mount 65. The controlling mask 75 is located an inner front wall of the housing 60. The fan 80 is arranged on an inner bottom surface of the housing 60. The fan 80 can be arranged in a heat dissipation hole formed on a rear wall of the housing 60 or the fan 80 can be arranged on a frame 63 to carry heat out of a heat dissipation hole 64 formed on each lateral wall of the housing 60. The voltage regulator circuit unit 85 is arranged on the inner bottom surface of the housing 60, whereby the voltage regulator circuit unit 85 switches between alternating currents and direct currents to stabilize the direct currents of the high power laser module 70 and the fan 80.

The high power laser module 70 dissipates heat only by the heat dissipation ring 71, and the fan 80 is arranged restrictively by space due to the volume, so as to fail to provide better heat dissipating efficiency.

Therefore, a second conventional high power semiconductor laser module is needed to provide better heat dissipation efficiency and high stability thereof. With respect to FIGS. 2 and 3, the second conventional high power semiconductor laser module includes a semiconductor heat dissipation module 10, a power controller 20 and a transmission media 30. The transmission media 30 connects the semiconductor heat dissipation module 10 to the power controller 20 for transferring power from the power controller 20 to the semiconductor heat dissipation module 10. The semiconductor heat dissipation module 40 includes a semiconductor laser module 40, two metallic members 401 and two heat conduction plates 402 arranged on a periphery of the semiconductor heat dissipation module 40, and a thermoelectric cooling chip 403 and a heat dissipation plate 404 connecting an exterior of a surface of each heat conduction plate 402. The power controller 20 includes a power-driving unit (not shown) to transform the input source into direct currents for the semiconductor laser module 40 and the thermoelectric cooling chip 403.

Heat from the semiconductor laser module 40 can be transferred through each of the two metallic members 401, each of the two heat conduction plates 402, the thermoelectric cooling chip 403, and the heat dissipation plate 404, and the second conventional high power semiconductor laser module provides better heat dissipation efficiency than the first one.

However, the thermoelectric cooling chip 403 is easily damaged in a moist environment due to mist condensing into water in the thermoelectric cooling chip 403 to reduce the heat dissipation efficiency of the second conventional high power semiconductor laser module.

Furthermore, the semiconductor heat dissipation module 10 and the power controller 20 are separate and should be connected to each other via the transmission media 30. The semiconductor laser module 40 can be excited easily by various environments to exchange an output power thereof.

Hence, an improvement over the prior art is required to overcome the disadvantages thereof.

### SUMMARY OF INVENTION

The primary object of the invention is therefore to specify a high power semiconductor laser lighting device that can combine a semiconductor laser lighting module, a fan module and a driving unit.

The secondary object of the invention is therefore to specify a high power semiconductor laser lighting device that can keep the temperature of a semiconductor laser constant-temperature module constant, so as to avoid exchanging an output power thereof with various environments.

The third object of the invention is therefore to specify a high power semiconductor laser lighting device that protects a thermoelectric cooling chip from mist to prevent the heat dissipation efficiency from decreasing.

According to the invention, these objects are achieved by a high power semiconductor laser lighting device comprising elements as follows. A housing includes a bottom wall, a top wall, a front wall, a rear wall and two sidewalls, the front wall having a lighting hole and a transparent member covering the lighting hole, and the rear wall has an exhaust hole formed therein. A fan module is arranged in the exhaust hole of the rear wall in the housing, the fan module including a heat dissipation plate. A base connects the bottom wall of the housing and is disposed on a side of the fan module. The base includes a driving unit, which has at least one high power electronic component connected on a surface of the heat dissipation plate. A semiconductor laser constant-temperature module is adjacent to the heat dissipation plate. The semiconductor laser constant-temperature module has a metallic partition to enclose a vacuum formed in a front portion of the housing, and a heat insulation layer arranged in the vacuum. The metallic partition has a side connecting the heat dissipation plate and an opposite side connecting a heating portion of a thermoelectric cooling chip, which includes a cooling portion connecting a semiconductor laser lighting module. The semiconductor laser lighting module has a lighting portion aligned with the lighting hole in the front wall of the housing, and the thermoelectric cooling chip electrically connects to the driving unit.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a first conventional high power semiconductor laser lighting device;

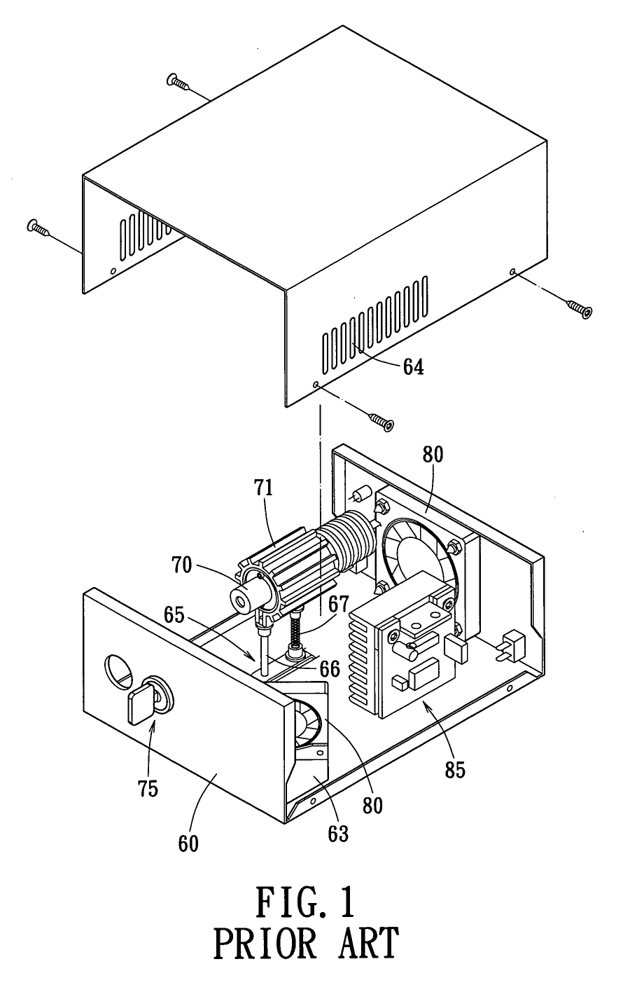

FIG. 2 is a perspective view of a second conventional high power semiconductor laser lighting device;

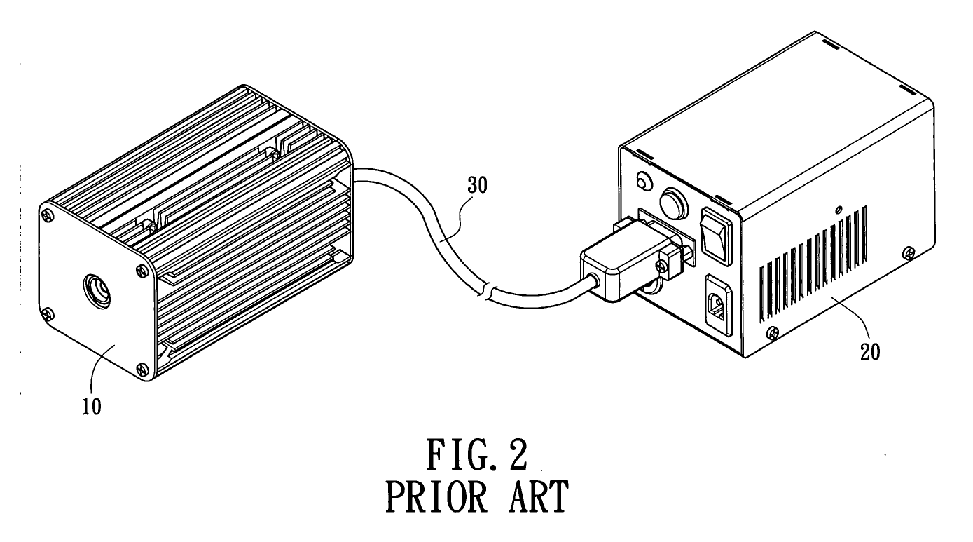

FIG. 3 is a decomposition view of the first conventional high power semiconductor laser lighting device according to FIG. 2;

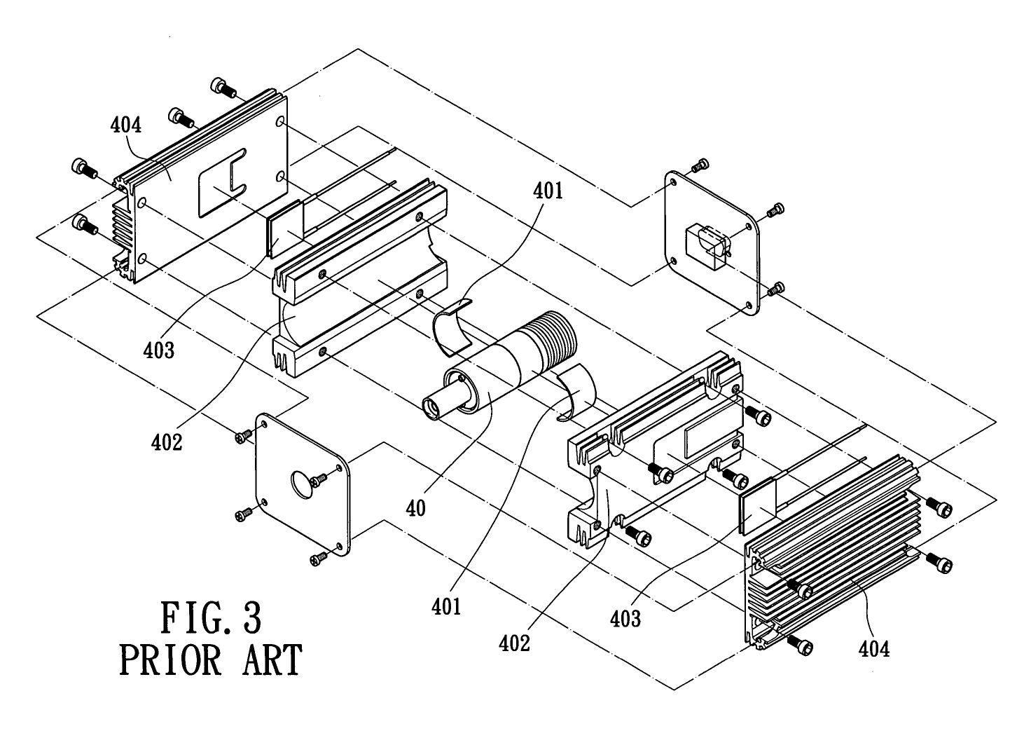

FIG. 4 is a perspective view of a high power semiconductor laser lighting device according to the present invention;

FIG. 5 is a decomposition view of the high power semiconductor laser lighting device according to the present invention; and

FIG. 6 is a cross-sectional profile of the high power semiconductor laser lighting device according to the present invention.

### DETAILED DESCRIPTION OF THE EMBODIMENTS

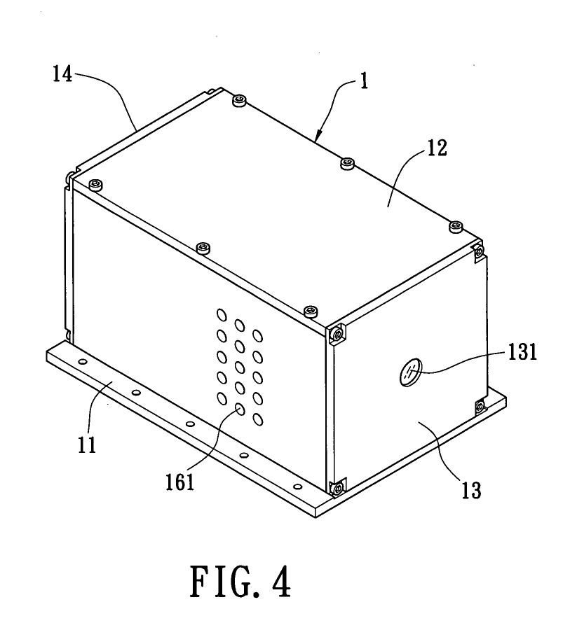

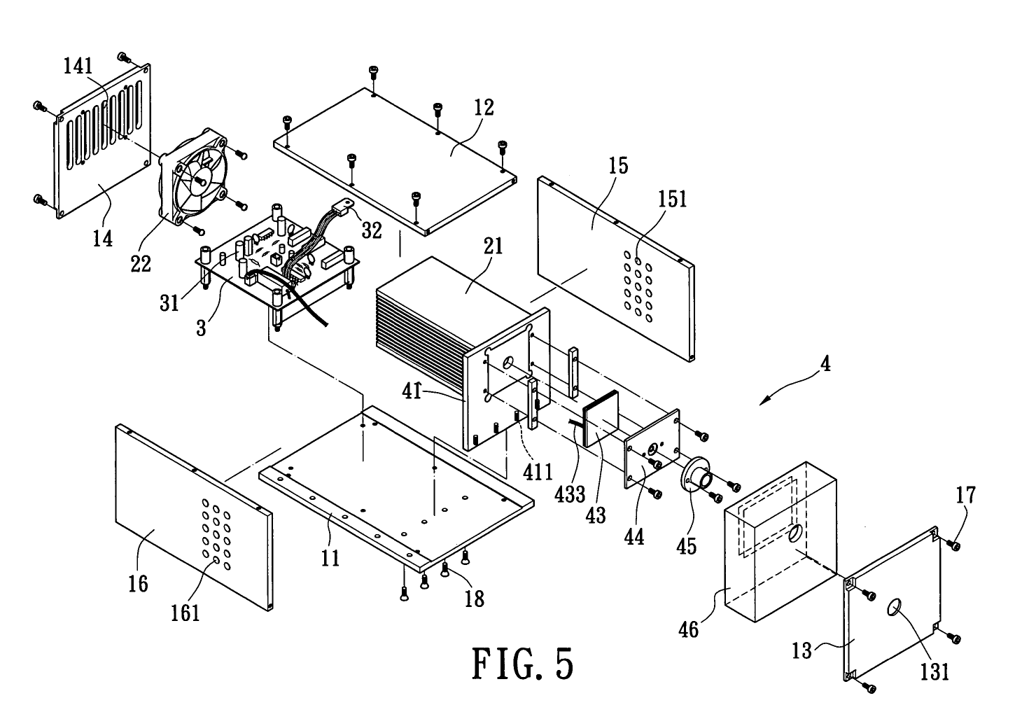

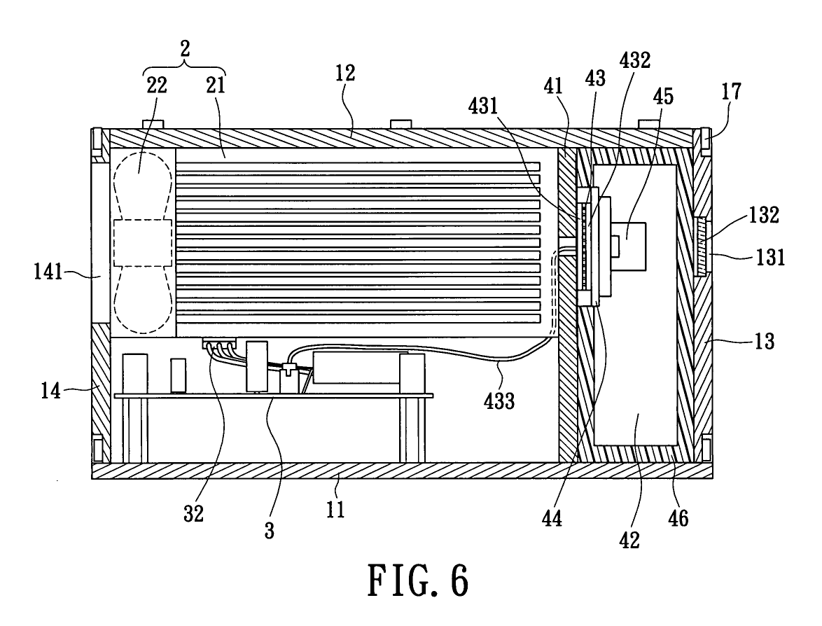

With respect to FIGS. 4 to 6, the present invention provides a high power semiconductor laser lighting device including a housing 1, a fan module 2, a base 3, and a semiconductor laser constant-temperature module 4.

The housing 1 includes a bottom wall 11, a top wall 12, a front wall 13, a rear wall 14 and two sidewalls 15, 16 via a plurality of screws 17. The front wall 13 has a lighting hole 131 and a transparent member 132, such as transparent tempered glass, covering the lighting hole 131. The rear wall 14 has an exhaust hole 141 formed therein, and each sidewall 15, 16 includes a plurality of through holes 151, 161 respectively formed therein.

The fan module 2 is arranged in the exhaust hole 141 of the rear wall 14 in the housing 1. The fan module 2 includes a heat dissipation plate 21, such as an aluminum extrusion heat sink with a plurality of fins disposed thereon, adjacent to a fan 22 to dissipate heat via the exhaust hole 141.

The base 3 connects to the bottom wall 11 of the housing 1 and is disposed on a side of the fan module 2. The base 3 includes a driving unit 31, which has at least one high power electronic component 32 connected to a surface of the heat dissipation plate 21 for heat dissipation.

The driving unit 31 includes a circuit driving the semiconductor laser constant-temperature module and the thermoelectric cooling chip for keeping the semiconductor laser constant-temperature module at a constant temperature and providing a temperature-controller feedback (not shown).

The semiconductor laser constant-temperature module 4 is adjacent to the heat dissipation plate 21. The semiconductor laser constant-temperature module 4 has a metallic partition 41 to enclose a vacuum 42 formed in a front portion of the housing 1, and a heat insulation layer 46 is arranged in the vacuum 42. The metallic partition 41 has a side connecting the heat dissipation plate 21 and an opposite side connecting to a heating portion 431 of a thermoelectric cooling chip 43, which includes a cooling portion 432 connecting to a semiconductor laser lighting module 45 via a metallic mounting plate 44. The semiconductor laser lighting module 45 has a lighting portion aligned with the lighting hole 131 of the front wall 13 of the housing 1 via the heat insulation layer 46, and the thermoelectric cooling chip 43 includes a power cable 433 electrically connects to the driving unit 31. The metallic partition 41 includes a plurality of screw holes 411 formed in a bottom thereof for a plurality of screws 18 to penetrate through the bottom wall 11 of the housing 1, so as to connect the metallic partition 41 to the housing 1.

When the semiconductor laser lighting module 45 is excited to generate heat, the metallic mounting plate 44 transfers the heat to the thermoelectric cooling chip 43. The cooling portion 432 thereof absorbs the heat therefrom and the heating portion 431 thereof releases the heat to the heat dissipation plate 21 via the metallic partition 41. The heat dissipation plate 21 can absorb not only the heat from the metallic partition 41, but also heat generated from the high power electronic component 32; thus the heat can be drawn out via the exhaust hole 141.

In addition, the metallic partition 41 connects to the bottom wall 11, the top wall 12, and the two lateral sidewalls of the housing 1. Heat generated by the semiconductor laser lighting module 45 can transferred via the housing 1.

The present invention is characterized by the following advantages:

(1) Increased heat dissipation efficiency is due to a combination of the fan module 2, the driving unit 31, and the semiconductor laser lighting module 45.

(2) The vacuum can prevent water from condensing on the thermoelectric cooling chip 43, which condensation would influence the semiconductor laser lighting module 45.

(3) Heat from the driving unit also can be transferred to increase the heat dissipation efficiency.

(4) The semiconductor laser lighting module 45 can maintain a constant temperature with a constant power output in various environments.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A high power semiconductor laser lighting device, comprising:
a housing including a bottom wall, a top wall, a front wall, a rear wall and two sidewalls, the front wall having a lighting hole therein and a transparent member covering the lighting hole, and the rear wall having an exhaust hole formed therein;
a fan module arranged in the exhaust hole of the rear wall in the housing, the fan module including a heat dissipation plate;
a base connecting to the bottom wall of the housing and disposed on a side of the fan module, the base including a driving unit, wherein the driving unit has at least one high power electronic component connected to a surface of the heat dissipation plate; and
a semiconductor laser constant-temperature module adjacent to the heat dissipation plate, the semiconductor laser constant-temperature module having a metallic partition to enclose a vacuum formed in a front portion of the housing, and a heat insulation layer arranged in the vacuum;
wherein the metallic partition has a side connected to the heat dissipation plate and an opposite side connected to a heating portion of a thermoelectric cooling chip, the cooling chip includes a cooling portion connecting to a semiconductor laser lighting module, the semiconductor laser lighting module has a lighting portion aligned with the lighting hole of the front wall of the housing, and the thermoelectric cooling chip electrically connects to the driving unit.

2. The high power semiconductor laser lighting device as claimed in claim 1, wherein the housing includes a plurality of through holes respectively formed in the two sidewalls.

3. The high power semiconductor laser lighting device as claimed in claim 1, wherein the transparent member is a transparent tempered glass.

4. The high power semiconductor laser lighting device as claimed in claim 1, further including a fan adjacent to the heat dissipation plate.

5. The high power semiconductor laser lighting device as claimed in claim 1, wherein the driving unit includes a circuit driving the semiconductor laser constant-temperature module and the thermoelectric cooling chip for keeping the semiconductor laser constant-temperature module at a constant temperature and providing a temperature-controller feedback.
